(19) United States
(12) Patent Application Publication
(10) Pub. No.: US 2011/0170580 A1
(43) Pub. Date: Jul. 14, 2011

(54) SIGNAL PROCESSING UNIT AND METHOD, AND CORRESPONDING TRANSCEIVER

(75) Inventors: Jules Pierre Lamoureux, St-Lazare (CA); Leo Laperriere, Laval (CA)

(73) Assignee: WAVESAT INC., Dorval, QC (CA)

(21) Appl. No.: 12/865,314

(22) PCT Filed: Jan. 29, 2008
(86) PCT No.: PCT/CA2008/000184

§ 371 Date: Apr. 5, 2011

(51) Int. Cl. H04B 1/38

(52) U.S. Cl. 375/222; 375/219

(57) ABSTRACT

A signal processing unit and a method for using the signal processing unit. The signal processing unit comprising at least two Digital Signal Processors (DSPs) and at least one memory for storing data. The DSP is adapted for signal processing and is capable of accessing the at least one memory. According to an embodiment, the signal processing unit is an Orthogonal Frequency-Division Multiplexing (OFDM) transceiver. The OFDM transceiver is adapted to receive and transmit signals.

### FIELD OF THE INVENTION

The invention relates to digital signal processing, and more specifically to sequential digital signal processing.

### BACKGROUND OF THE INVENTION

Devices that are capable of interpreting signals such as electric signals, electromagnetic waves, sound waves, etc. are used in numerous technological fields. The signals carry messages from one device to another or from one electronic component to another. Following the reception of a signal, the device must interpret the signal to extract the message. Alternatively, for a device to transmit a message, the message must be transformed for it to be carried over a signal and properly interpreted by a receiving device.

The process of interpreting signals or transforming messages requires several processing steps that are executed by a digital signal processor (DSP). The DSP is a specialized microprocessor that is specifically designed for digital signal processing. DSPs are only capable of processing digital signals; analog signals must therefore be converted into the digital format beforehand. Following the analog to digital conversion of the signal, processing of the converted data is ready to take place. The processing operations are complex since a single set of data contains multiple dimensions of valuable information. As the complexity of the processing operations increase, the processing power must be increased to properly interpret the data in a timely fashion.

Generally, DSPs are used to provide faster instruction sequences that are commonly used in math-intensive signal processing. DSPs offer improvements on general microprocessors that are commonly used, as microprocessors are essentially general-purpose devices that are used to run large blocks of software. DSPs in contrast, are microprocessors that often function as embedded controllers or processors; they are found on-board various types of devices and are used to implement a specific group of tasks.

The DSP is used in a wide array of applications, and is used to perform specific functions. For example, the DSP may perform various functions including, data compression, data decompression, function transforms, removing signal interference, frequency amplification, frequency filtering, data encryption and waveform analysis. As the DSP is used for various functions, it is considered as a component that generates a bottle-neck in the flow of data to be processed.

An effort to reduce the energy usage and improve the speed of signal processing is taking place. In U.S. Pat. No. 6,023,641, Thompson proposes a parallel organization of DSPs to reduce power consumption in medical devices. According to Thompson, each DSP functions at a reduced clock frequency to reduce power consumption. However, in applications that require processing of data blocks (such as in an OFDM modem where the FFT size dictates the block size), additionally memory storage is required and an efficient method of transferring information and data between memory units is also required.

### SUMMARY OF THE INVENTION

The present invention relates to a system and method for using multiple sequential Digital Signal Processors (DSPs) and memory blocks in a device that has, among others, the functionality of performing digital signal processing related functions. Additionally, the system and method use memory that is accessible by at least one of the sequential DSPs.

It will be apparent to one skilled in the art that an organization of sequential DSPs, and memory are variable. The organization of sequential DSPs, and memory are defined following a group of predetermined objectives or following a single objective. According to an embodiment of the invention, the DSPs are dedicated to sub-functionalities and related to memory according to attain an objective such as reducing energy consumption, cost or latency.

According to an embodiment of the present invention, the organization of sequential DSPs and memory is used in a transceiver. More specifically, the organization of sequential DSPs, and memory is used for data signal processing of block data, such as in an Orthogonal Frequency-Division Multiplexing (OFDM) transceiver.

### BRIEF DESCRIPTION OF THE DRAWINGS

For a better understanding of embodiments of the systems and methods described herein, and to show more clearly how they may be carried into effect, reference will be made by way of example, with reference to the accompanying drawings in which:

FIG. 1 is a block diagram depicting components of a wireless modem;

FIG. 2a is a block diagram depicting modules contained within an integrated circuit chip of a wireless modem;

FIG. 2b, FIG. 2c and FIG. 2d are block diagrams of exemplary embodiments of memory units and sequential Digital Signal Processors (DSPs) relations;

FIG. 3 is a block diagram of the components of a programmable DSP;

FIG. 4a, FIG. 4b and FIG. 4c are block diagrams of exemplary embodiments of sequential DSPs and sub-functionality relations;

FIG. 5 is a block diagram depicting components of a wireless modem;

FIG. 6 is a block diagram depicting modules contained within an integrated circuit chip of an OFDM transceiver; and

FIG. 7 is a flowchart diagram of a method for using at least two DSPs.

### DETAILED DESCRIPTION OF THE INVENTION

Over the years, technological requirements have become increasingly demanding, devices must be smaller and lighter, yet must run faster and consume as little energy as possible. It has therefore become increasingly important to create devices that perform tasks in an efficient manner. The present invention concerns devices that have as a task, among others, to process signals. Signal processing devices are present in several fields of technology, such as in electronics, in telecommunication, in biomedicine, etc. The present invention does not limit itself to a specific field, it applies to any device performing digital signal processing.

In the field of wireless communication, consumers prefer to use devices that offer an extended duration of battery life. The longer the duration of the battery life, the longer the usage duration of the device without having to replace or charge the battery. Alternatively, there are applications that require an increase in the execution speed while maintaining a level of energy consumption that is similar or lower than what was used in the past. New features on wireless communication devices require, in some instances, added processing time. Users are ready to accept the new features as long as they do not compromise speed of the device. The same applies to any other field that uses devices functioning in an environment where use of energy and processing time must be closely watched.

It is an objective of the present invention to reduce energy consumption and/or to increase the processing speed of Digital Signal Processors (DSPs). The present invention may be implemented on a wide array of electronic circuits, such as: electronic circuits on a single board, inter-connected electronic circuit boards or integrated circuits designed to accomplish various or specific tasks. One particular application is described herein, in an exemplary embodiment. The exemplary embodiment is described with respect to integrated circuits associated with a wireless modem. For purposes of example, the wireless modem is described generally, as one that may implement the IEEE Standard 802.16 wireless protocol. It will however, be understood that integrated circuit described as the subject of the present invention, may be used in a wide array of applications, and the wireless modem has been used for purposes of example only.

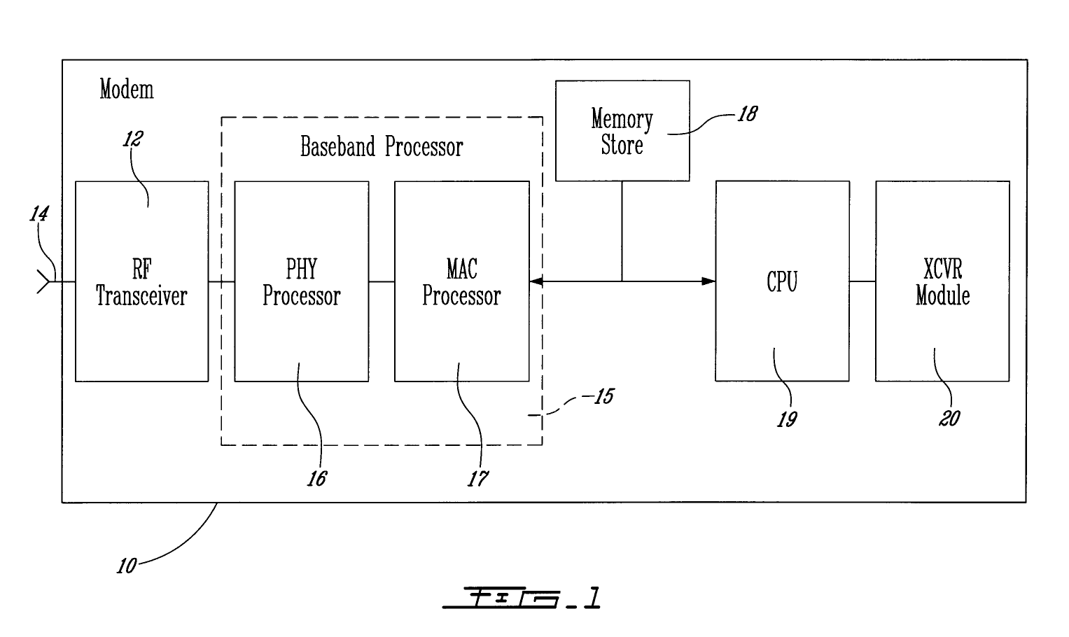

Reference is made to FIG. 1, where a wireless modem 10 and its constituent components are shown in accordance with one embodiment. The wireless modem 10 may be any type of modem 10 that allows for RF communication or Microwave communication using any given communication protocol. In this case, the wireless modem 10 is shown as a modem 10 that implements the WiMAX protocol. The wireless modem 10 is comprised of a radio frequency (RF) transceiver 12, an antenna 14, and a PHY Processor 16. A person skilled in the art will understand that the wireless modem 10 has possible other components such as a media access control (MAC) processor 17, a memory store 18, a central processing unit 19, an Ethernet controller module 20, etc. The PHY Processor 16 and the MAC Processor 17 are referred to as the baseband processor 15.

Data is transmitted to and from the wireless modem 10 thanks to RF electromagnetic waves. When the modem 10 is in reception mode, the antenna 14 is ready to capture electromagnetic waves. During reception, the captured electromagnetic waves induct an electric current in the antenna 14. Alternatively, when the modem 10 is in transmission mode, the antenna 14 is ready to transmit electromagnetic waves. During transmission, the current running through the antenna 14 generates the electromagnetic waves to send out. The electromagnetic waves are the means for transporting data between two devices and the electric current is the means for transporting data through a device. As a result, the electric current transporting data is a signal that must be properly interpreted for it to be adequately processed.

The antenna 14 is connected to the RF transceiver 12 acting as a signal interpreter. In reception mode, the RF transceiver 12 conditions the received signal for further processing. Among other things, the RF transceiver 12 removes from the signal impurities that are known to people skilled in the art as noise. In transmission mode, the RF transceiver 12 conditions the signal to send out, this helps in maintaining the data accuracy while in transit. It will be appreciated by a person skilled in the art that the RF transceiver 12 functions only as a RF transmitter or only as a RF receiver.

According to the present embodiment, the RE transceiver 12 is connected to the baseband processor 15, where the baseband processor 15 is used to implement the appropriate wireless transmission and reception protocol. In other words, the baseband processor 15 is used to carry out signal processing functions. It will be apparent to a person skilled in the art that the referenced baseband processor 15 is replaceable by any other type or combination of types of signal processing units.

### DSP and Memory

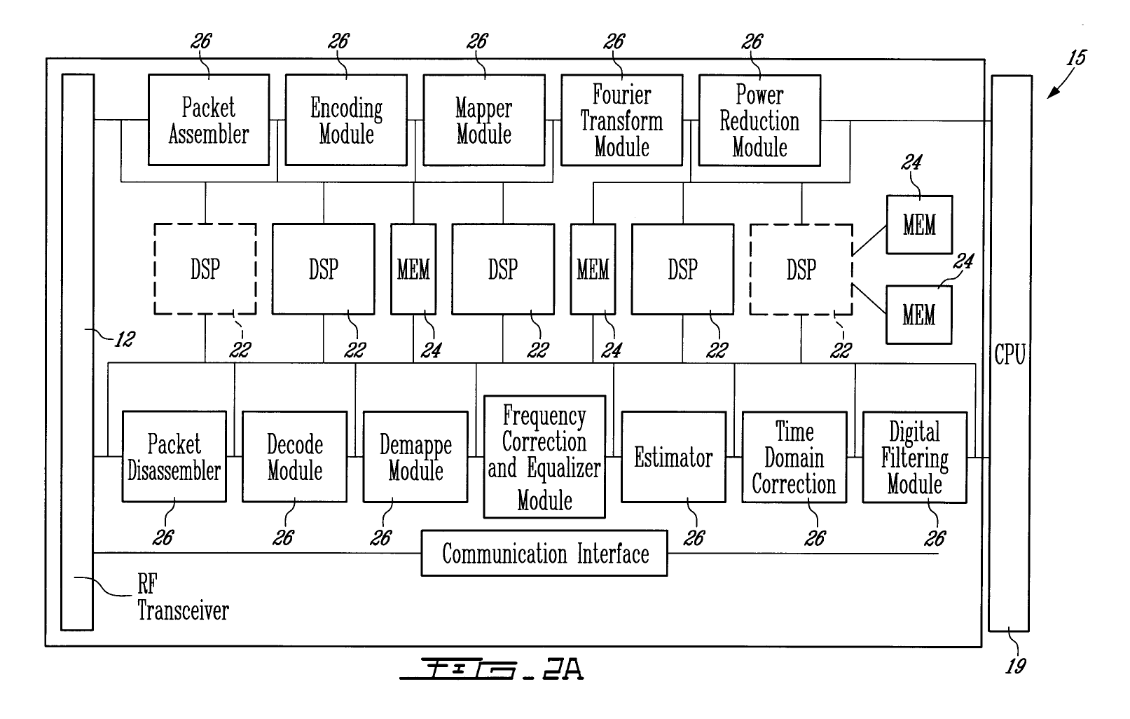

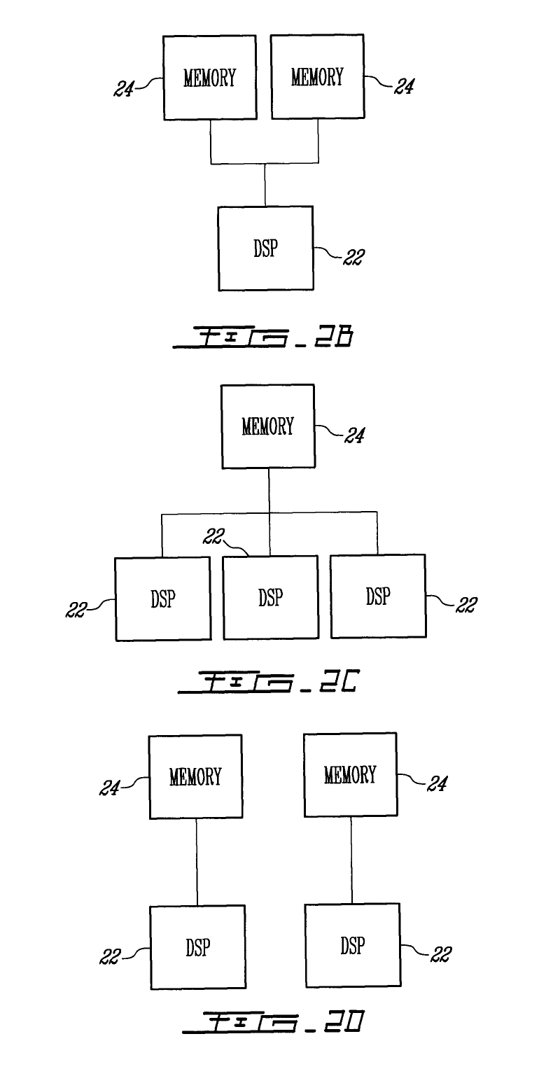

Presented in FIG. 2a is an exemplary embodiment of the baseband processor 15, in which a plurality of DSPs 22 are sequentially organized. A DSP 22 can be either a programmable DSP 22 or hardware DSP 22, such as an FFT engine. According to the present embodiment, a first DSP 22 is connected to the RF transceiver 12 and a last DSP 22 is connected to the CPU 19. It will be understood by a person skilled in the art that the organization and the number of the sequential DSPs 22 is variable depending on the requirements of the baseband processor 15.

Several different types and combination of types of sequential DSP 22 and memory 24 usages are possible. Presented in FIG. 2b multiple memory 24 units are shared by a single DSP 22. Alternatively, presented in FIG. 2c a single memory 24 is shared by multiple DSPs 22. In another embodiment of the present invention, each memory 24 is used by a single DSP 22, as presented in FIG. 2d.

Returning to FIG. 2a, according to another embodiment of the present invention, the DSP 22 is a bidirectional signal processor. The DSP 22 is therefore capable of performing signal processing for transmission of a signal and for reception of a signal. It will however be evident for a person skilled in the art that a device having solely unidirectional sequential DSP 22 or a combination of unidirectional DSP 22 and bidirectional DSP 22 is possible. Furthermore, the DSP 22 is adapted to either transfer data to another DSP 22 or to store data into memory 24. Similarly, the DSP 22 is adapted to receive data from another DSP 22 or to retrieve data from memory 24.

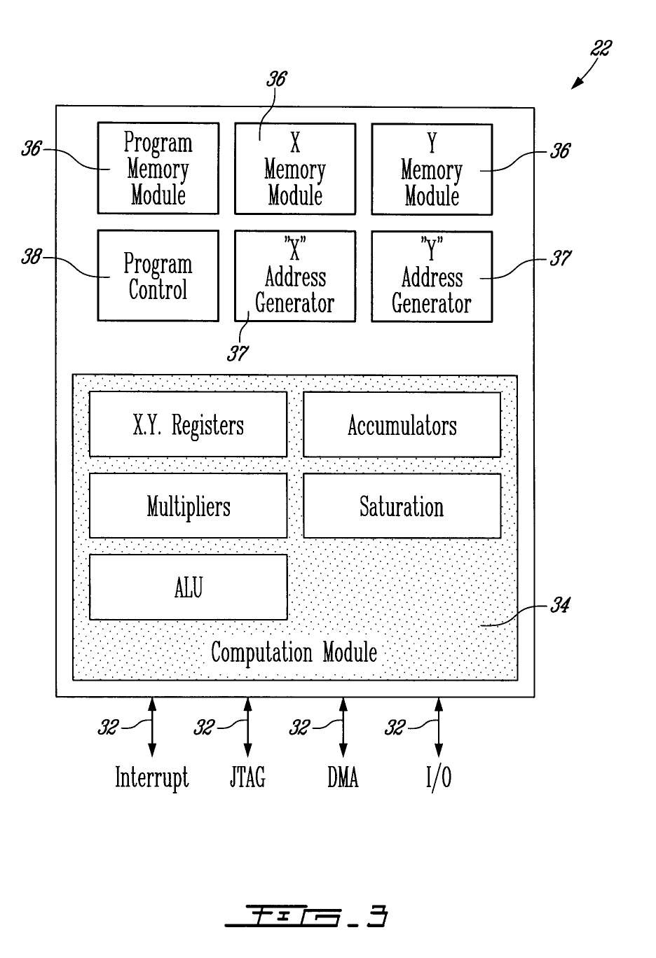

Further presented in FIG. 3, according to another embodiment of the present invention, each DSP 22 has a same design, each DSP 22 has ports 32 such as an Interrupt port 32 for event processing, a Join Test Action Group (JTAG) port 32 for testing purposes, a Direct Memory Access (DMA) port 32 for accessing memory 24 and an I/O port 32 for data transfer. It will be understood by a person skilled in the art that for different DSPs 22 to have a different set of ports 32 depending on the requirements of the DSP 22. Additionally, according to another embodiment of the present invention, the DSPs 22 each have a different set of ports 32.

According to another embodiment of the present invention, the DSP 22 has a computational module 34 that has several sub-modules that interact and allow specific mathematical operations. Additionally, the DSP 22 has several other modules such as internal memory modules 36 and address generators 37 that provide addresses for stored data in a specific memory module. A program control 38 unit assures the proper flow for the different memory modules 36.

Although the device in the previous exemplary embodiments is a modem 10, it will be understood by a person skilled in the art that the device may further be any other device that requires to perform signal processing such as a transceiver, a transmitter, a receiver, a communication unit, etc.

### Sub-Functionalities

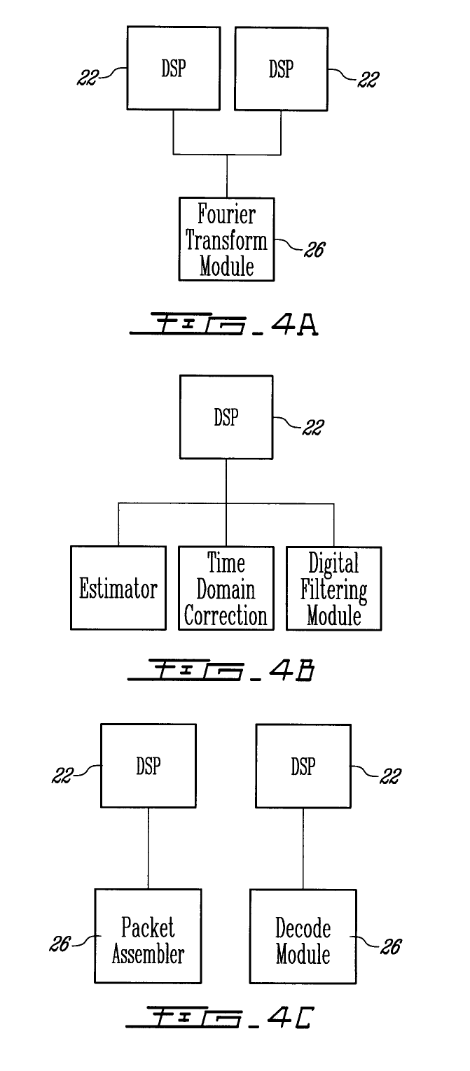

The DSP 22 is dedicated to perform signal processing for a set or subset of sub-functionalities 26. Further presented in FIG. 2a, according to an exemplary embodiment of the baseband processor 15, the DSPs 22 are dedicated to perform specific sub-functionalities 26. According to an embodiment, several DSPs 22 must cooperate to perform signal processing based on several sub-functionalities 26. Additionally, as presented in FIG. 4a, it will be appreciated by a person skilled in the art that an organization of multiple DSPs 22 dedicated to perform the processing of a single sub-functionality 26 is, in some cases, desirable. For instance, such an organization of DSP 22 is desirable when a time consuming sub-functionality 26 must be executed by multiple DSPs 22, either in parallel or in sequence. Alternatively, as presented in FIG. 4b, among the sequential DSPs 22 of the baseband processor 15, a single DSP 22 that is dedicated to perform multiple sub-functionalities 26 is also in some cases desirable. For instance, sub-functionalities 26 that are not time consuming are executed by a single DSP 22. Presented in FIG. 4c, is another embodiment of the solution where sequential DSPs 22 are each dedicated to a single sub-functionality 26. It will be appreciated to one skilled in the art that any combination of DSP 22 and sub-functionality 26 dedication scheme is possible in the baseband processor 15.

### DSP Unit

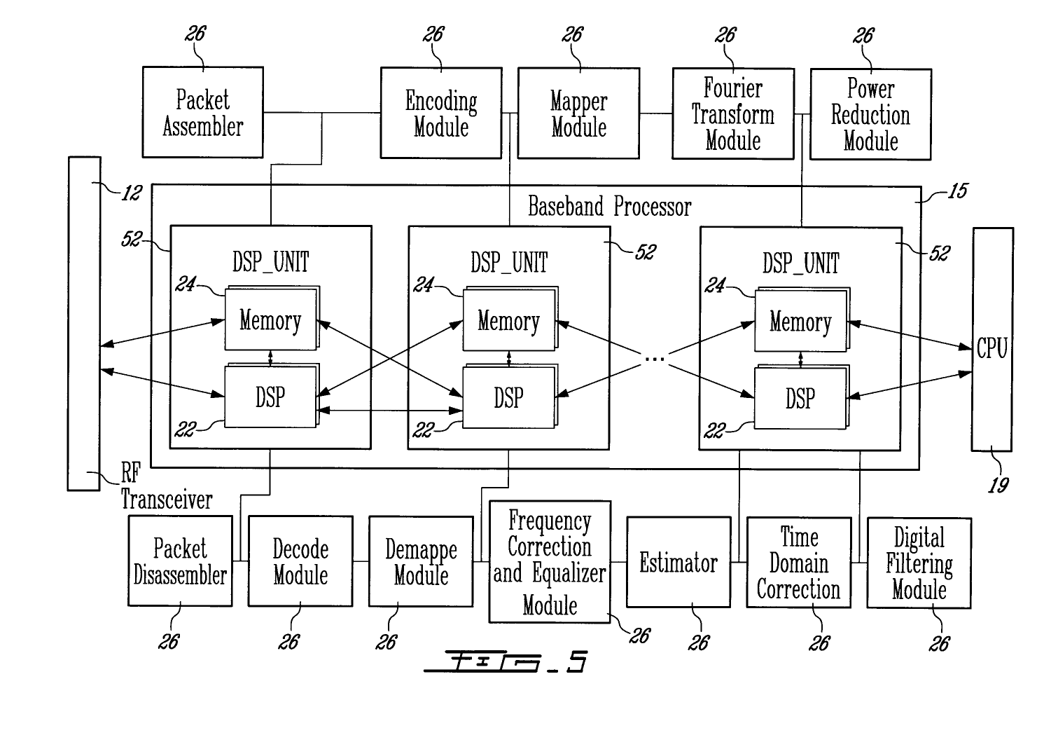

Presented in FIG. 5, according to another embodiment of the present invention, the baseband processor 15 comprises sequential DSP units 52. A DSP unit 52 comprises at least one DSP 22 and at least one memory 24. According to the present embodiment, a first DSP unit 52 is connected to the RF transceiver 12 and a last DSP unit 52 is connected to the CPU 19. It will be understood by a person skilled in the art that the organization and the number of the sequential DSP units 52 is variable depending on the requirements of the baseband processor 15.

The internal configuration of the DSP unit 52 is adapted to the sub-functionalities 26 the DSP unit 52 is dedicated thereto. According to an embodiment, the DSP unit 52 comprises sequentially accessible DSPs 22. According to another embodiment, the DSP unit 52 comprises DSPs 22 that are accessible in parallel. It will be apparent to a person skilled in the art that a DSP unit 52 comprises a combination of sequential and parallel DSPs 22. Additionally, according to the sub-functionality 26 each DSP unit 52 is dedicated thereto, the DSPs 22 are adapted to access each other from one DSP unit 52 to another. Alternatively, the DSPs 22 belonging to the same DSP unit 52 are adapted to access each other.

Further presented in FIG. 5, a DSP 22 is adapted to access memory of the same DSP unit 52. Alternatively, a memory 24 of one DSP unit 52 is accessible by a DSP 22 of another DSP unit 52. It will be apparent to a person skilled the art that the DSPs 22 and the memory units 24 of a DSP unit 52 have different possible configurations as previously presented in FIGS. 2b, 2c and 2d.

According to an embodiment, the baseband processor 15 has at least one DSP unit 52 and at least one DSP 22 that are accessible sequentially. In the present embodiment, the DSP 22 is adapted to access memory of the DSP unit 52. It will be apparent to a person skilled in the art that the DSP 22 accesses another memory or accesses directly the DSP 22.

According to another embodiment, the baseband processor 15 has a single DSP unit 52 with sequential DSPs 22 and at least one memory therein. It will be apparent to people skilled in the art that at least one of the sequential DSPs 22 of the present embodiment is adapted to access memory located outside the DSP unit 52.

### OFDM Transceiver

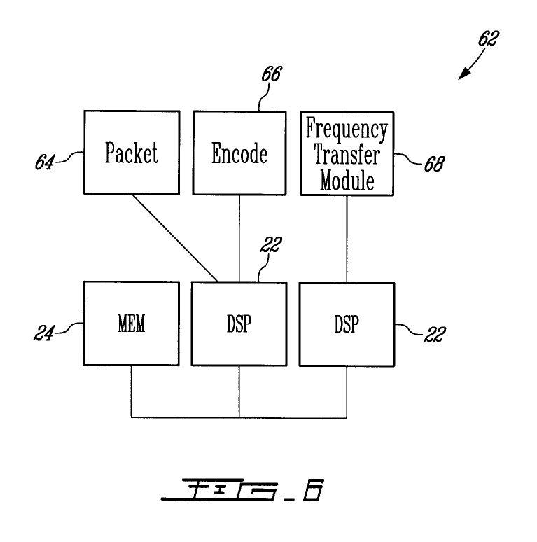

Presented in FIG. 6, according to another embodiment of the present invention, an Orthogonal Frequency-Division Multiplexing (OFDM) transceiver 62 for receiving and transmitting signals has sequentially organized DSPs 22. The OFDM transceiver 62 has an organization of sequential DSPs 22. Just as in the modem 10 of FIG. 1, the organization of sequential DSPs 22 is variable.

Further presented in FIG. 6, sub-functionalities 26 are presented as functional modules such as packet processing module 64, encoding module 66 and frequency transformation module 68. Depending on the area of application, other functional modules are in some instances present. In an OFDM transceiver 62, a packet processing module 64 is responsible to process packets for assembly or disassembly of data. An encoding module 66 is responsible to encode or decode data. A frequency transformation 68 module is responsible of transforming data in time domain or transforming data in the frequency domain.

According to an embodiment of the present invention, each functional module is connected to a sequential DSP 22. However, depending on the functional modules, a person skilled in the art will understand that in some cases, the functional modules are not all connected to a sequential DSP 22. Additionally, according to an embodiment of the present invention, a functional module is connected to multiple sequential DSPs 22. Such an organization of functional modules and DSPs 22 is desirable when the functional module necessitates several sequential operations or several parallel operations.

### Method

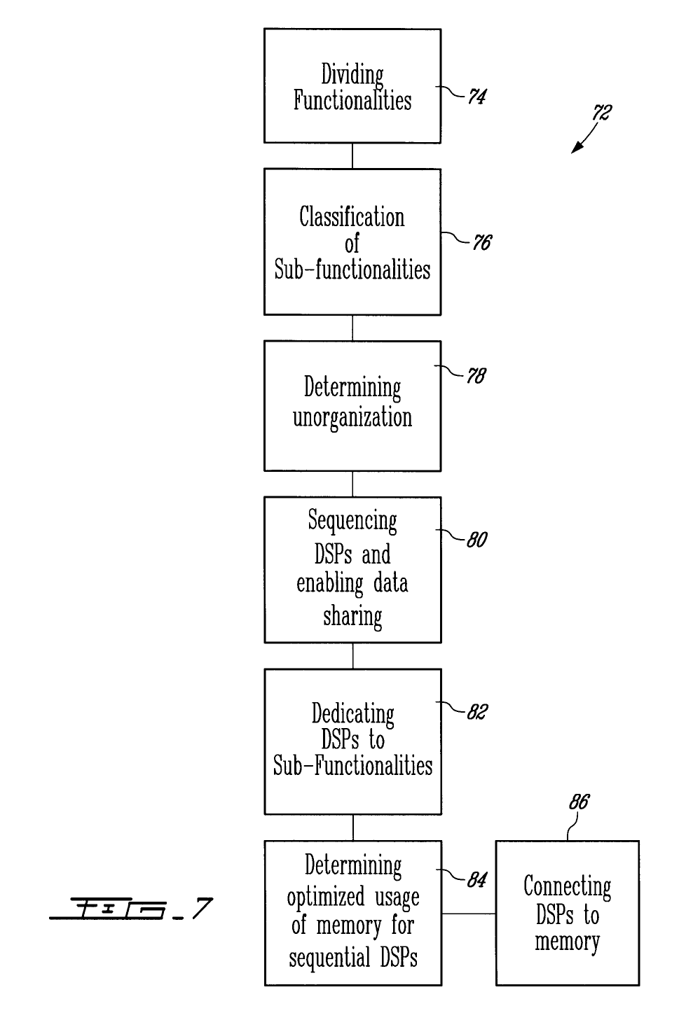

In FIG. 7 is presented a method 72 of using at least two DSP units 52. A first step 74 requires dividing a signal processing functionality into at least two sub-functionalities 26. According to an embodiment of this method, a second step 76 requires to classify the sub-functionalities 26 based on their required energy consumption. According to another embodiment of this method, the second step 76 requires to classify the sub-functionalities 26 based on their memory access requirements or memory storage requirements. Alternatively, according to another embodiment of the present invention, the second step 76 requires to classify the sub-functionalities 26 based on their required execution time consumption. It will be apparent for one skilled in the art that any other classification rules or combination of classification rules is used depending of the requirements for using at least two DSP units 52.

Further presented in FIG. 5, a third step 78 requires determining an organization of sequential DSP units 52 for the classified sub-functionalities 26. According to an embodiment of the present invention, the organization of DSP units 52 and sub-functionalities 26 is determined as to optimized and limit the energy consumption of the baseboard processor 15. According to another embodiment of the present invention, the organization of DSP units 52 and sub-functionalities 26 is determined as to optimize and minimize the execution time of the sub-functionalities 26. It will be apparent to a person skilled in the art that other objectives or combination of objectives are used for optimizing the organization of the DSPs 22 and sub-functionalities 26.

Further presented in FIG. 5, a fourth step 80 requires to sequence the DSP units 52 and enable data sharing between the DSP units 52, by following the previously determined organization. People skilled in the art will acknowledge that some sequential DSP units 52 do not share data and therefore are not required to be enabled for data sharing. A fifth step 82 requires dedicating at least one sequential DSP unit 52 to at least one sub-functionality 26 according to the determined organization.

Further presented in FIG. 5, a sixth step 84 requires defining an optimized usage of at least one memory 24 for at least one DSP 22 of at least one DSP unit 52. According to an embodiment of the present invention, the optimized usage of memory 24 for the DSP 22 is determined according to the memory usage of each DSP 22. Alternatively, according to another embodiment of the present invention, the optimized usage of memory 24 for the DSPs 22 is determined to reduce execution time. A person skilled in the art will understand that any other objective or combination of objectives for optimizing memory 24 usage is acceptable.

Further presented in the FIG. 5, a seventh step 86 requires connecting the DSPs 22 to the memory 24 according to the determined optimized memory 24 usage. It is to be noticed that the above steps are to be implemented in any combination, iteration or order. Furthermore some steps may be omitted and some steps may be replaced by other steps.

The present method and system have been described with regard to preferred embodiments. The description as much as the drawings were intended to help the understanding of the method and system, rather than to limit its scope. It will be apparent to one skilled in the art that various modifications may be made to the solution without departing from the scope or the solution as described herein, and such modifications are intended to be covered by the present description.

1. A signal processing unit comprising:
at least two sequential Digital Signal Processors (DSPs) adapted for signal processing; and
at least one memory for storing data, said at least one memory being accessible by at least one of said sequential DSPs.

2. The signal processing unit of claim 1 wherein at least one of said sequential DSPs is adapted to be dedicated to at least one particular signal processing sub-functionality.

3. The signal processing unit of claim 2 wherein at least one of said sequential DSPs is adapted to transfer data to at least one other of said sequential DSPs.

4. The signal processing unit of claim 1 wherein said at least two sequential DSPs are adapted to handle bi-directional signal processing.

5. Use of the signal processing unit of claim 1, in one of the following: a transceiver, a transmitter, a receiver, a communication unit, or a modem.

6. The signal processing unit of claim 1 further comprises at least two sequential DSP units wherein at least one of said sequential DSP and said at least one memory is located.

7. A method for using at least two Digital Signal Processors (DSPs) comprising:
dividing a signal processing functionality into at least two sub-functionalities;
classifying said at least two sub-functionalities according to their consumption requirements;
determining an organization of the at least two DSP for said at least two sub-functionalities; and
sequencing said at least two DSP units and enabling data sharing between said at least two DSP units, according to said organization.

8. The method for using at least two DSPs of claim 7 further comprising:
dedicating at least one of said at least two DSPs to at least one of said at least two signal processing sub-functionalities, according to said organization.

9. The method for using at least two DSPs of claim 7 further comprising:
defining an optimized usage of at least one memory for said at least two DSP units.
defining an optimized usage of at least two sequential DSPs for said at least two DSP units.
connecting at least one of said at least two DSPs to said at least one memory, according to said optimized usage.

10. The method for using at least two DSPs of claim 7 wherein said consumption is energy consumption.

11. The method for using at least two DSPs of claim 10 wherein said organization is an optimized organization for reducing energy consumption.

12. The method for using at least two DSPs of claim 7 wherein said consumption is execution time consumption.

13. The method for using at least two DSPs of claim 12 wherein said organization is an optimized organization for reducing execution time consumption.

14. The method for using at least two DSPs of claim 9 wherein said optimized usage is for reducing execution time.

15. An Orthogonal Frequency-Division Multiplexing (OFDM) transceiver comprising:
a transceiver unit adapted to receive and transmit signals; and
at least two sequential Digital Signal Processors (DSPs) adapted for processing received and transmitted signals.

16. The OFDM signal processing unit of claim 14 further comprising at least one memory for storing data, said at least one memory being connected to at least one of said sequential DSPs.

17. The OFDM signal processing unit of claim 14 wherein said transceiver unit comprises functional modules for signal processing sub-functions, at least one of said functional module is connected to at least one of said sequential DSPs.

18. The OFDM signal processing unit of claim 15 wherein said functional modules comprises: a packet processing module, an encoding module and a frequency transformation module.
